(19) United States
(12) Patent Application Publication
(10) Pub. No.: US 2014/0245130 A1
(43) Pub. Date: Aug. 28, 2014

(54) DEVICES, SYSTEMS, AND METHODS FOR COMMUNICATING WITH AN IMAGE-FORMING DEVICE

(71) Applicants: Canon U.S.A., Inc., Melville, NY (US); Canon Information and Imaging Solutions, Inc., Melville, NY (US)

(72) Inventors: Manuel P. Ferreira, Long Beach, CA (US); Royce E. Slick, Mission Viejo, CA (US); Craig Mazzagatte, Aliso Viejo, CA (US)

(73) Assignees: Canon U.S.A., Inc., Melville, NY (US); Canon Information and Imaging Solutions, Inc., Melville, NY (US)

(21) Appl. No.: 14/187,109

(22) Filed: Feb. 21, 2014

Related U.S. Application Data
(60) Provisional application No. 61/768,312, filed on Feb. 22, 2013.

(51) Int. Cl. G06F 17/22

(52) U.S. Cl. CPC G06F 17/2247
USPC 715/234

(57) ABSTRACT

Systems, devices, and methods for communicating with an image-forming device obtain a web page from a web server at a browser, wherein the web page includes an iframe; render the web page on the browser; populate the iframe with information received from the image-forming-apparatus-communication application; send first information from the web page to the iframe; and send the first information from the iframe to the image-forming-apparatus-communication application.

### CROSS-REFERENCE TO RELATED APPLICATIONS

This application claims priority to U.S. Provisional Application No. 61/768,312, which was filed on Feb. 22, 2013, which is hereby incorporated by reference.

### BACKGROUND

1. Technical Field

This description generally relates to scanning, additive manufacturing, and subtractive manufacturing.

2. Background

In the field of scanning, additive manufacturing, and subtractive manufacturing, devices often include user interfaces that allow users to control the operations of the respective device. For example, by means of a user interface, a user can select the options for print settings, such as paper size, double-sided printing, color, grayscale, borderless printing, etc.

### SUMMARY

In one embodiment, a device for communicating with an image-forming device comprises one or more computer-readable media; one or more input interfaces; one or more output interfaces; and one or more processors that are coupled to the one or more computer-readable media, the one or more input interfaces, and the one or more output interfaces, and that are configured to cause the device to perform operations including obtaining a web page from a web server, wherein the web page includes an iframe, populating the iframe with information received from a first image-forming-apparatus-communication application, sending first information from the web page to the iframe, and sending the first information from the iframe to a second image-forming-apparatus-communication application.

In one embodiment, a method for communicating with an image-forming device comprises obtaining a web page from a web server at a browser, wherein the web page includes an iframe and identifies an image-forming-apparatus-communication application; rendering the web page on the browser; populating the iframe with information received from the image-forming-apparatus-communication application; sending first information from the web page to the iframe; and sending the first information from the iframe to the image-forming-apparatus-communication application.

In one embodiment, one or more computer-readable media store instructions that, when executed by one or more computing devices, cause the one or more computing devices to perform operations that comprise obtaining a web page from a web server at a browser, wherein the web page includes an iframe; rendering the web page on the browser; populating the iframe with information received from an image-forming-apparatus-communication application; sending first information from the web page to the iframe; and sending the first information from the iframe to the image-forming-apparatus-communication application.

### BRIEF DESCRIPTION OF THE DRAWINGS

FIG. 1 illustrates an example embodiment of a system for communicating with an image-forming device (IFD).

FIG. 2 shows an example embodiment of a JavaScript that includes a RESTful API.

FIG. 3 illustrates an example embodiment of the flow of information in a system for communicating with an IFD.

FIG. 4 illustrates an example embodiment of an operational flow for communicating with an IFD.

FIG. 5 illustrates an example embodiment of a system for communicating with an IFD.

FIG. 6 illustrates an example embodiment of a system for communicating with an IFD.

FIG. 7 illustrates an example embodiment of a system for communicating with an IFD.

FIG. 8 illustrates an example embodiment of a system for communicating with an IFD.

FIG. 9 illustrates an example embodiment of the flow of information in a system for communicating with an IFD.

FIG. 10 illustrates example embodiments of operational flows for communicating with an IFD.

FIG. 11 illustrates example embodiments of operational flows for communicating with an IFD.

FIG. 12 illustrates an example embodiment of a user interface that may be displayed on a web page.

FIG. 13A illustrates an example embodiment of a system for communicating with an IFD.

FIG. 13B illustrates an example embodiment of a system for communicating with an IFD.

FIG. 14A illustrates an example embodiment of a system for communicating with an IFD.

FIG. 14B illustrates an example embodiment of a system for communicating with an IFD.

### DESCRIPTION

The following disclosure describes certain explanatory embodiments. Other embodiments may include alternatives, equivalents, and modifications. Additionally, the explanatory embodiments may include several novel features, and a particular feature may not be essential to some embodiments of the devices, systems, and methods described herein.

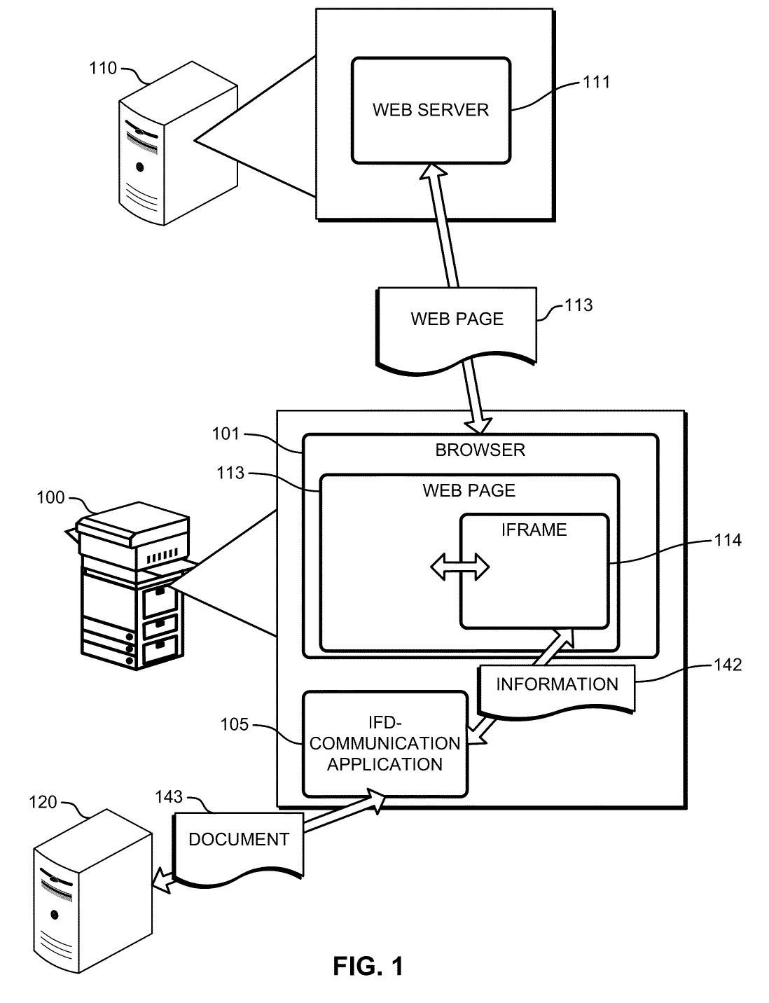

FIG. 1 illustrates an example embodiment of a system for communicating with an image-forming device (IFD) 100. The system includes a server 110 and an IFD 100. The IFD 100 may be, for example, a scanner, an additive-manufacturing device (e.g., a laser printer, an inkjet printer, and a three-dimensional printer), or a subtractive-manufacturing device. Using the system, a user can communicate with the IFD 100 by means of a browser 101 that renders a web page 113 that is served by the server 110. Also, the browser 101 performs much or most of the processing, which reduces the processing burden of the server 110. In some embodiments, the server 110 and the browser 101 do not need to communicate after the server 110 sends the web page 113 to the browser 101.

The server 110 operates a web server 111, which serves a web page 113 that includes resources (e.g., images, a script, and Cascading Style Sheets) and that defines an iframe 114 that is to be populated with information from the IFD-communication application 105. The browser 101 may request a web page 113 that corresponds to the IFD 100 or may identify the IFD 100 for which a web page 113 is requested. Also, the web page 113 or the iframe 114 may identify an IFD 100 or an IFD-communication application 105 that can populate the iframe 114.

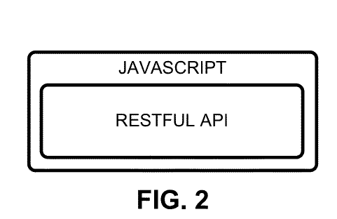

The web page 113 may include JavaScript that includes a RESTful API (e.g., the JavaScript is a wrapper for the RESTful API), as illustrated by FIG. 2. Thus, some embodiments of the system leverage on-device RESTful APIs and combine them with HTML/CSS/JavaScript so that the browser 101 (i.e., the device that operates the browser 101) does more processing and the server 110 does less processing. This approach may provide a lighter-weight, rapid-application-development platform for developing solutions for an IFD. For example, some embodiments of the system use a RESTful interface that is provided on the IFD 100. JavaScript APIs facilitate the calling of these RESTful service APIs on the IFD 100. These JavaScript APIs can then be used by JavaScript code that is embedded in the web page 113. This allows web developers to easily access the RESTful service APIs by using a familiar web-development language, such as JavaScript (which is sometimes referred to as ECMAScript). However, although JavaScript and REST are generally used in the description of the example embodiments that are presented herein, some embodiments use scripts other than JavaScript and use service APIs other than REST (e.g., SOAP).

The IFD 100 operates a browser 101 that renders the web page 113, including the iframe 114. The iframe 114 and the web page 113 (e.g., a respective script operating on each) communicate with one another, for example by setting the other's URL or by using event messaging. Event messaging may include, for example, posting an event using the JavaScript window.postMessage function. For example, in some embodiments the iframe 114 sends information to the web page 113 by setting the URL of the web page 113, and the web page 113 sends information to the iframe 114 by setting the URL of the iframe 114.

The IFD 100 also operates an IFD-communication application 105 that communicates with the iframe 114. The IFD-communication application 105 may be a dedicated web-server application. Also, the IFD-communication application 105 relays information 142 (e.g., print-job information) between the iframe 114 and the other applications and processes that are running on the IFD 100, for example a multifunctional embedded application platform. Functionally, the IFD-communication application 105 may expose one or more APIs of the IFD 100. Also, the IFD-communication application 105 can communicate with an image server 120, which implements an image-server service and sends one or more images (e.g., documents 143) to the IFD 100. An image can be identified by means of a uniform resource identifier (URI), which may include a uniform resource locator (URL) or a uniform resource name (URN). Also, the image-server service of this embodiment and the other embodiments described herein may serve other types of images (e.g., photographs, graphics, files in an Additive Manufacturing File Format, and files in an STL file format).

Furthermore, depending on the embodiment, the web server 111 that sends the web page to the browser 101 may be hosted on the IFD 100, on a computing cloud, on a dedicated web-server device, or on another computing device. Also, depending on the embodiment, the image (e.g., the document 143) can be stored on a computing cloud, on a remote server, on the IFD 100, or on another computing device. Additionally, even if the web server 111 on the server 110 operates outside of a firewall, an IFD-communication application 105 that operates inside the firewall can still retrieve an image that is stored on a computing device that is inside the firewall (in addition to retrieving images that are stored outside the firewall). Also, in some embodiments the web server 111 does not receive the document's URI or any other information about the document, which may improve security.

Thus, embodiments of the system that is illustrated by FIG. 1 may provide several advantages, which may include one or more of the following: the ability to avoid a round trip to a web server for device communication; the web server 111 may be located on premise or in a computing cloud, or the web server 111 may even be hosted on the IFD itself; the web server may be OS or platform independent; no additional web-server components or processing may be required on the server side; the web server 111 may serve a web page that includes only HTML and JavaScript embedded with some CSS; and finally, developers may be able to write their custom applications using primarily HTML/CSS/JavaScript, rather than performing server-side development.

Accordingly, some embodiments of the system enable the development, for devices that have limited capabilities, of web applications that are capable of sending device commands directly to an IFD 100 without going back up through a central server; provide a mechanism for enabling the forming of images that are stored on a website or in a network location; and provide a mechanism for enabling a mobile computing device (e.g., a tablet, and a smart phone) to use the same web application that the IFD 100 uses to display the web page 113 on a front-panel display of the IFD 100, which may give a user the same user experience regardless of the device.

Additionally, the computing devices (i.e., the server 110, the IFD 100, the image server 120) in the embodiment of the system that is illustrated in FIG. 1 and the other embodiments described herein each include one or more processors (CPU), one or more I/O interfaces, and storage/memory. The CPUs each include one or more central processing units, which include microprocessors (e.g., a single core microprocessor, and a multi-core microprocessor) or other circuits, and the CPUs are configured to read and perform computer-executable instructions, such as instructions in storage or in memory. The computer-executable instructions may include those for the performance of the operations described herein. The I/O interfaces include communication interfaces for input and output devices, which may include a keyboard, a display, a mouse, a printing device, a touch screen, a light pen, an optical-storage device, a scanner, a microphone, a camera, a drive, and a network (either wired or wireless).

Storage/memory includes one or more computer-readable or computer-writable media, for example a computer-readable storage medium. A computer-readable storage medium, in contrast to a mere transitory, propagating signal, includes a tangible article of manufacture, for example a magnetic disk (e.g., a floppy disk, and a hard disk), an optical disc (e.g., a CD, a DVD, and a Blu-ray disc), a magneto-optical disk, magnetic tape, and semiconductor memory (e.g., a non-volatile memory card, flash memory, a solid-state drive, SRAM, DRAM, EPROM, and EEPROM). The storage/memory is configured to store computer-readable data or computer-executable instructions.

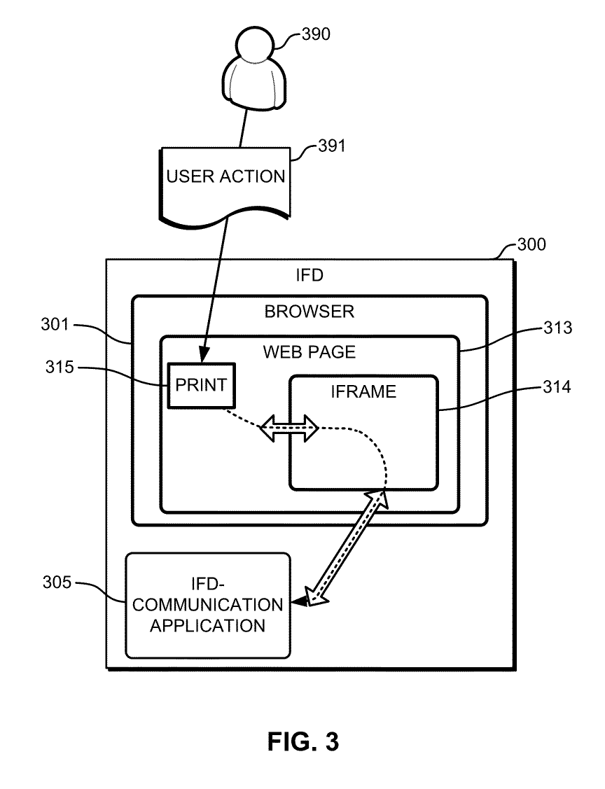

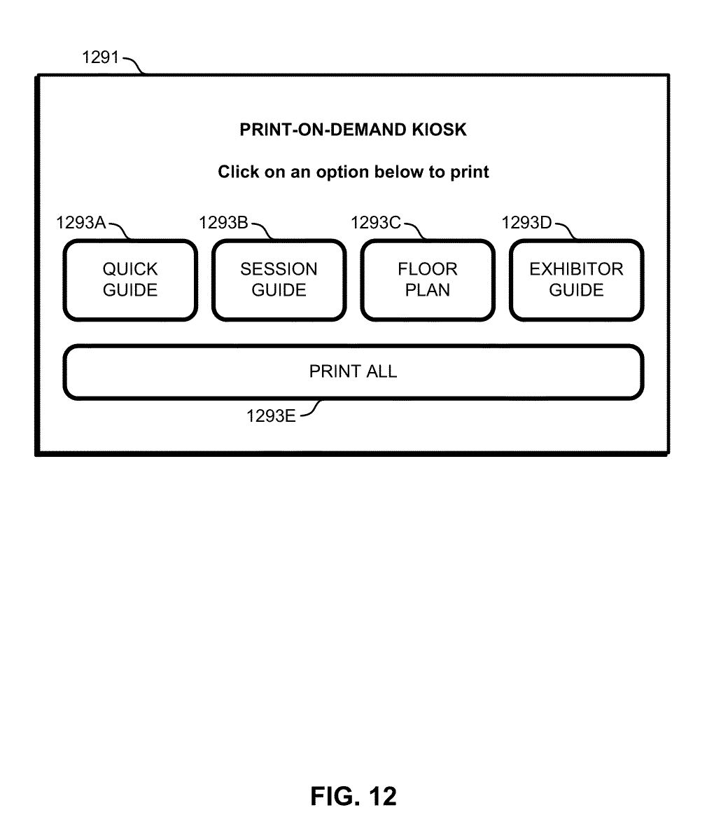

FIG. 3 illustrates an example embodiment of the flow of information in a system for communicating with an IFD 300. After a web server on a server has sent a web page 313, which includes an IFD-control interface (e.g., the embodiment of a user interface that is illustrated by FIG. 12), to a browser 301 that is operating on an IFD 300, the browser 301 renders the web page 313, which is presented on a display of the IFD 300. A user action 391 by a user 390 activates a print control 315 for the IFD 300 that is included in the IFD-control interface of the web page 313. The web page 313 sends information (e.g., a request to print, a storage location of an image, a message, and a command) that is related to the print control 315 to the iframe 314, which then sends the information to the IFD-communication application 305. The IFD-communication application 305 then sends the information to the appropriate application or service of the IFD 300, and the IFD 300 then performs any requested functions.

For example, to print a requested document (or other image), a user action 391 activates a print control 315 for a requested document on the web page 313. In response to the activation of the print control 315, a script on the web page 313 retrieves the URI of the requested document and sends information that includes a print request, the URI of the requested document, and, in some embodiments, print settings (e.g., duplex print, color, staple, page orientation, and part or all of a PrintTicket), to the iframe 314 by setting the URL of the iframe 314, for example to 123.12.1.1\iframeURL\#printdocumentatURL‘111.1.2.3’,duplexprint=yes. A script operating on the iframe 314 polls for updates to the URL of the iframe 314, detects the new URL, and extracts the information, including the print request. The iframe 314 then sends the request and the other information to an IFD-communication application 305 (e.g., according to an API for the IFD-communication application). The IFD-communication application 305 receives the print request and the accompanying information, and the IFD 300 retrieves the requested document using the document's URI and prints the document. The IFD-communication application 305 may also send a job number to the iframe 314. If the iframe 314 receives a check-status request from the web page 313 for the print job, the iframe 314 uses the job number to request the job's status from the IFD-communication application 305. Upon receiving the job status, the iframe 314 sends the status to the web page 313 by changing the URL of the web page 313, and the web page 313 obtains the status from the updated URL of the web page 313 and updates the web page 313 to display the result.

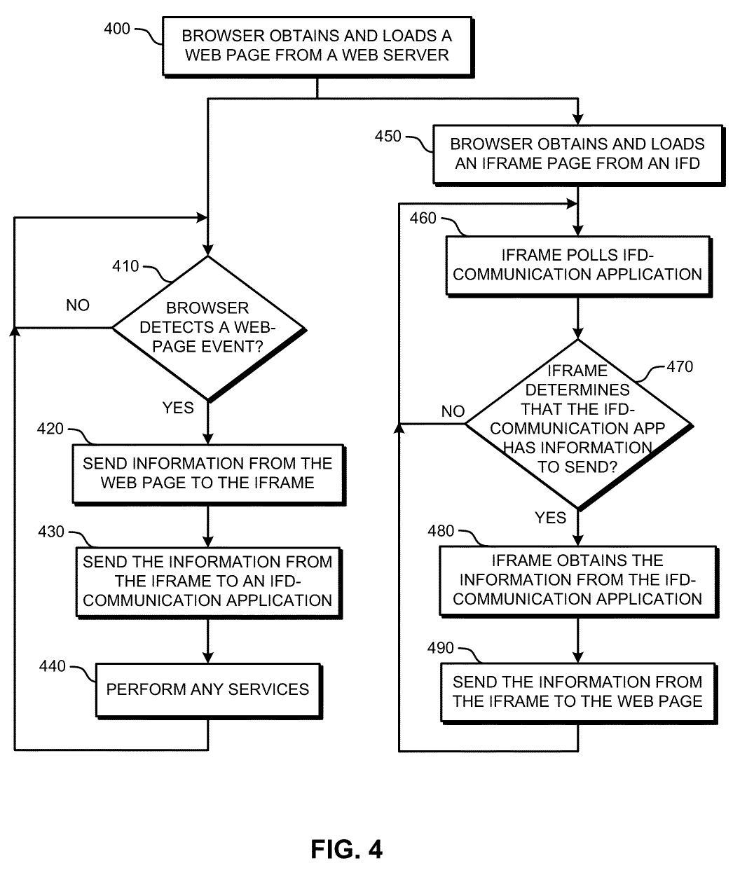

FIG. 4 illustrates an example embodiment of an operational flow for communicating with an IFD. The blocks of this operational flow and the other operational flows described herein may be performed by one or more computing devices, such as the systems and devices described herein. Also, although this operational flow and the other operational flows described herein are each presented in a certain order, some embodiments may perform at least some of the operations in different orders than the presented orders. Examples of possible different orderings include concurrent, overlapping, reordered, simultaneous, incremental, and interleaved orderings. Thus, other embodiments of this operational flow and the other operational flows described herein may omit blocks, add blocks, change the order of the blocks, combine blocks, or divide blocks into more blocks.

The flow starts in block 400, where a browser obtains and loads a web page from a web server. The flow then splits into two flows. One flow moves to block 410, where the browser determines if a web-page event (e.g., a message event, or an updated URL) is detected in the web page. An event may be generated, for example, in response to the user activating a control on the web page or by a script that is running on the web page. If no web-page event is detected (block 410=NO), this flow repeats block 410. If an event is detected (block 410=YES), then this flow moves to block 420, where event information (e.g., commands, requests, and messages) is sent from the web page to the iframe (e.g., via the URL, or via a message event). The flow then proceeds to block 430, where the event information is sent from the iframe to an IFD-communication application. Next, in block 440, the IFD performs any services (e.g., forming an image, responding to a status request, and changing output settings), and then this flow returns to block 410.

The other flow moves from block 400 to block 450, where the browser obtains and loads an iframe page that is received from an IFD-communication application. Next, in block 460, the iframe polls an IFD-communication application (which may be the same IFD-communication application that sent the iframe page or a different IFD-communication application) to determine the status of the IFD-communication application. This flow then moves to block 470, where the iframe determines if the status in the IFD-communication application's response indicates that the IFD has information to send to the iframe. If the result of the determination is no (block 470=NO), then this flow returns to block 460. If the result of the determination is yes (block 470=YES), then this flow moves to block 480. In block 480, the iframe obtains the information from the IFD-communication application. Next, in block 490, the iframe sends the information to the web page (e.g., via the URL of the web page, or via a message event). After block 490, this flow returns to block 460.

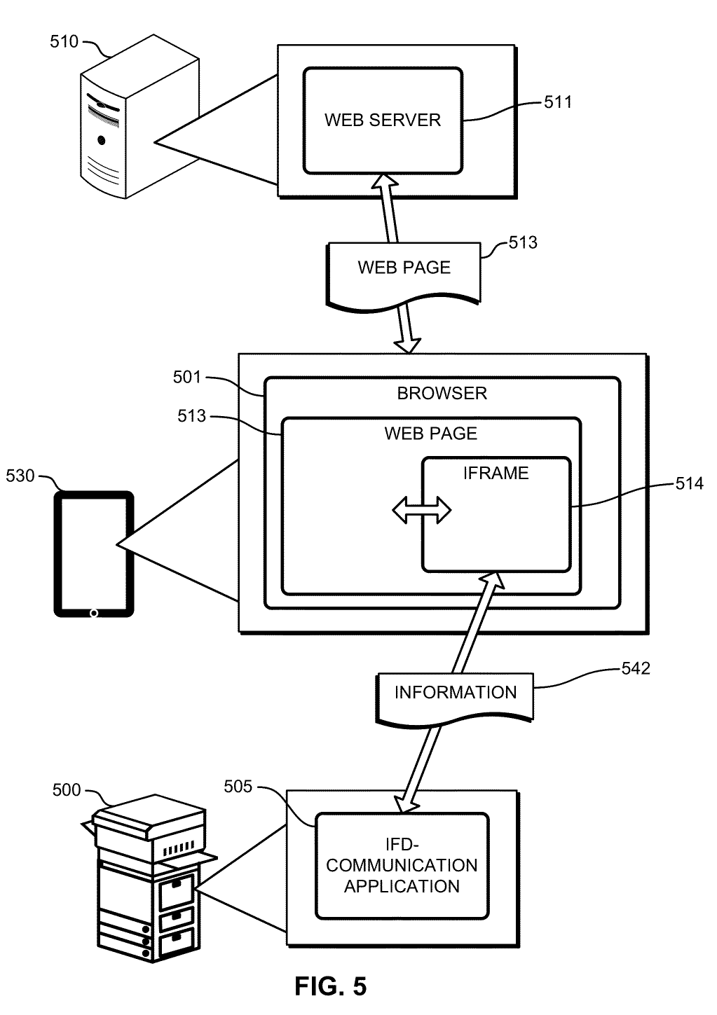

FIG. 5 illustrates an example embodiment of a system for communicating with an IFD. The system includes a server 510, an IFD 500, and a user-interface device 530, which is also a computing device (e.g., a laptop, a desktop, a tablet, a smart phone, a portable-digital assistant). The user-interface device 530 communicates with the IFD 500 and the server 510 by means of one or more networks (e.g., LANs, WANS, and peer-to-peer connections) or other wired or wireless channels, and the user-interface device 530 may communicate with the IFD 500 using a different network or channel than the user-interface device 530 uses to communicate with the server 510. The user-interface device 530 operates the browser 501, which obtains the web page 513 from the web server 511. The iframe 514 sends information to or receives information from the web page 513, and also relays information 542 between the IFD-communication application 505 and the web page 513.

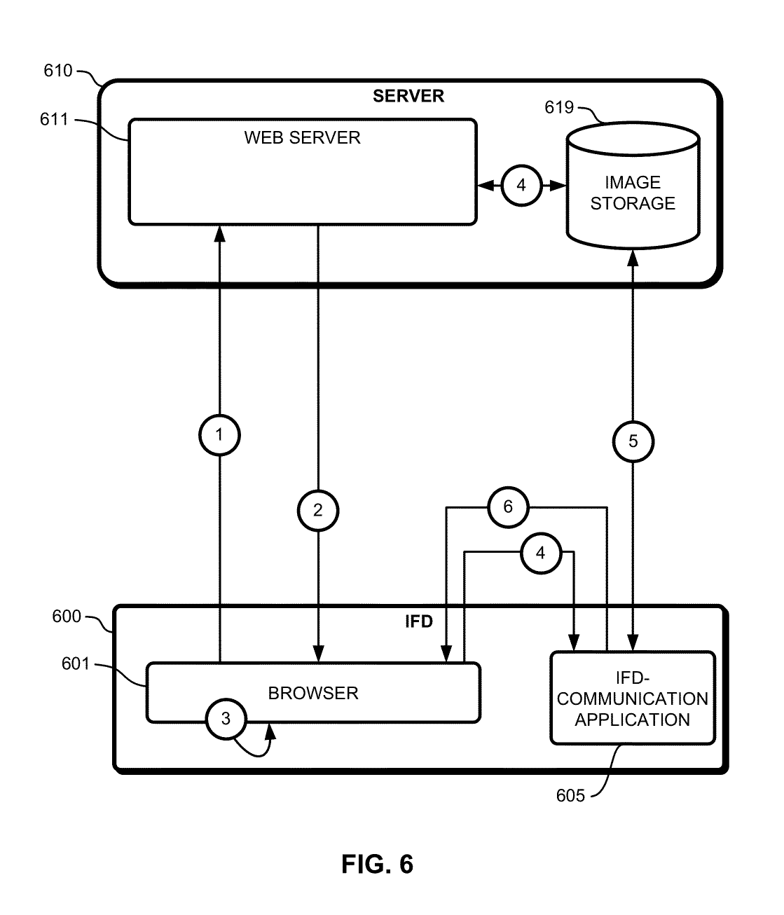

FIG. 6 illustrates an example embodiment of a system for communicating with an IFD, and FIG. 6 also illustrates the flow of operations in the embodiment of the system. This embodiment of the system includes a server 610 and an IFD 600. The server 610 operates a web server 611. Also, the server 610 includes image storage 619. Thus, in this embodiment, the server 610 also implements an image-server service. Additionally, the IFD 600 operates a browser 601 and an IFD-communication application 605.

In this example, the system performs a printing service. When performing the printing service, in stage 1 the browser 601 sends a request for a web page to the web server 611. In stage 2, the web server 611 sends a web page to the browser 601. The web page may include script tag references for JavaScript functions for printing or scanning. In stage 3, the browser 601 receives a print request for a document (or other image) by means of an interface on the web page. Then in stage 4, the browser 611 operates a script on the web page that calls a print function of the iframe and that passes information that includes the URI of the document to the iframe, and the iframe sends a pull-print request and the URI of the document to the IFD-communication application 605. Following, in stage 5, the IFD-communication application 605 uses the URI of the document to obtain the document from the image storage 619, and the IFD 600 begins to perform the operations that are required to print the document. Finally, in stage 6, the IFD-communication application 605 sends print-job-status information to the web page by means of the iframe, and the web page may updates its display to show the print-job-status.

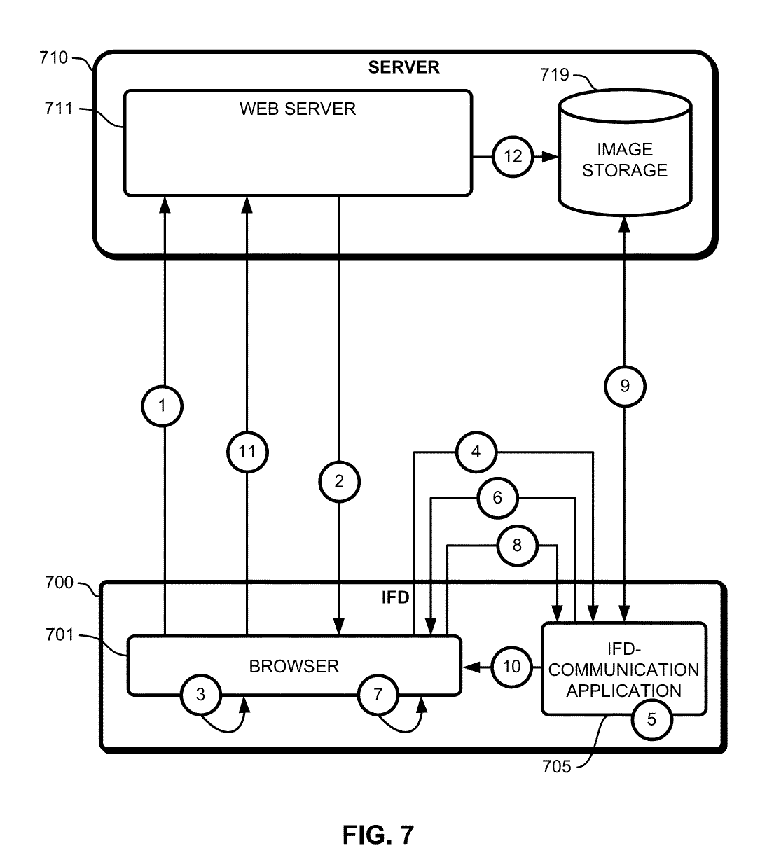

FIG. 7 illustrates an example embodiment of a system for communicating with an IFD, and FIG. 7 also illustrates the flow of operations in the embodiment of the system. This embodiment of the system includes a server 710 and an IFD 700. The server 710 operates a web server 711. Also, the server 710 includes image storage 719. Thus, in this embodiment the server 710 implements an image-server service. Additionally, the IFD 700 operates a browser 701 and an IFD-communication application 705.

In stage 1, the browser 701 sends a request for a web page to the web server 711. In stage 2, the web server 711 sends a web page to the browser 701, and the browser 701 renders the web page and renders an iframe, which includes populating the iframe with information that is received from the IFD-communication application 705. The web page, the iframe, or both may include script tag references for JavaScript functions for printing or scanning. In stage 3, the web page receives a scan request by means of an interface on the web page, and the web page sends the request to the iframe. Next, in stage 4 the iframe sends the scan request (e.g., via a ScanREST API) to the IFD-communication application 705. Following, in stage 5 the IFD-communication application 705 initiates the performance of a scan by the IFD 700. Then in stage 6, the IFD-communication application 705 sends a URI of the scan job to the iframe, which sends the URI to the web page. The web page (e.g., a script operating on the web page) may use the URI to obtain the scan job and display the scanned document.

Next, in stage 7, the web page receives a send-document request, which identifies a scanned document to send and a location (in this example, the image storage 719) where the document is to be sent, and the web page passes the request to the iframe. In stage 8, the iframe sends the send-document request to the IFD-communication application 705. In stage 9, the IFD-communication application sends the scanned document to the image storage 719. Also, the image storage 719 sends the storage location (e.g., URI, reference ticket) of the scanned document to the IFD-communication application 705. Then in stage 10, the IFD-communication application 705 sends the results of the send-document request, the storage location, or both to the web page by means of the iframe. Some embodiments perform stage 11 and stage 12. In stage 11, the web page sends the storage location to the web server 711. In stage 12, the web server 711 uses the received storage location to retrieve the scanned document from the image storage 719 and sends the scanned document to another storage location.

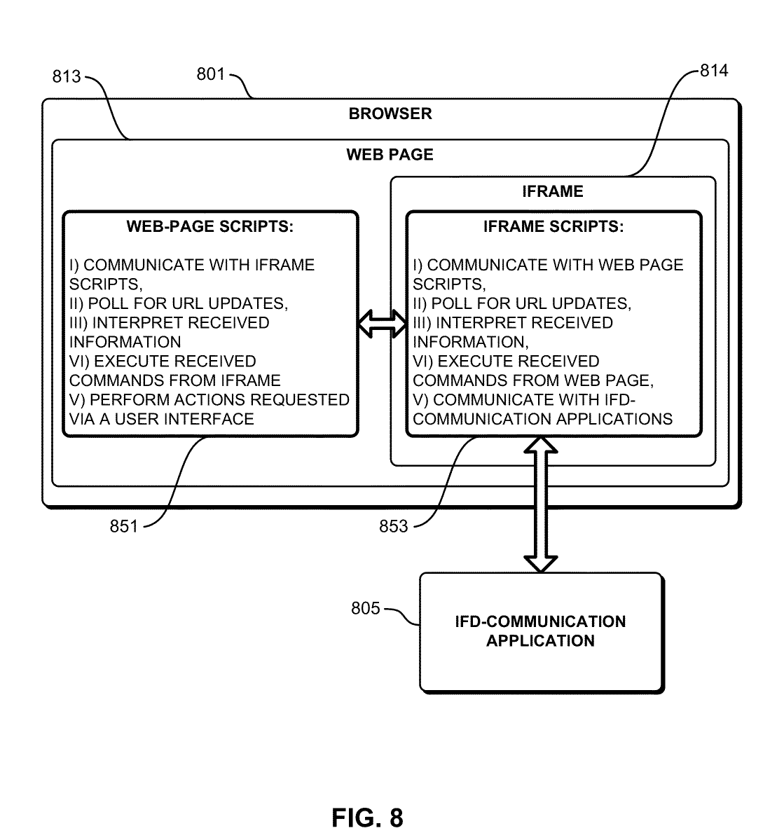

FIG. 8 illustrates an example embodiment of a system for communicating with an IFD. The system includes a computing device that implements a browser 801, which renders a web page 813 that includes an iframe 814. The web page 813 also includes web-page scripts 851, and the iframe includes iframe scripts 853. The web-page scripts 851 communicate with the iframe scripts 853; poll for URL updates, in some embodiments; interpret received information (e.g., in updated URLs, or from a message event); execute requests that are received from the iframe; and perform actions that are received via a user interface of the web page 813. The iframe scripts 853 communicate with the web-page scripts 851; poll for URL updates, in some embodiments; interpret received information (e.g., in updated URLs, or in a message event); execute requests that are received from the web page 841, and communicate with one or more IFD-communication applications 805.

For example, in some embodiments where the iframe 814 and the web page 813 communicate by setting the URL of the other, to avoid refreshing the entire web page 813 or the entire iframe 814 (which may reset the scripts), when a URL is set it may include a location, for example a hash tag ‘#’ followed by a request or a message. Also, the browser 801 may be configured to not refresh a web page 813 when it receives a URL that includes the hash tag. For example, a request may be formatted as “147.184.16.123/cwiframe/#‘action’:‘print’:printjobURL‘123.34.1.1’”. The requests and messages (e.g., the portion after the hash tag) may be required to obey a specified format. The following is an example of the hash-tag format: http://146.184.16.62:8000/accessible.html?ip=146.184.16.94&scheme=http&port=8000#136133 066081554&{“task”:“print”,“action”:“event”,“eventCallback”:“printStatusUpdate”,“jobStatus”:“printing”}. As illustrated by this example, a hash tag may include different fields (e.g., task, action, eventCallback, and jobStatus) and respective values (e.g., print, event, printStatusUpdate) for the fields. Thus, in some embodiments, scripts (e.g., JavaScript) in the web page 813 and the iframe 814 poll for changes to their respective URL locations, extract requests and messages from the URL locations, perform the requests, and send responses to the messages, if necessary. Also, the iframe 814 sends requests and messages to the IFD-communication application 805 to instruct an IFD to perform requested operations.

Therefore, in some embodiments, even if the web page 813 is received from a web server that operates on a device other than the IFD, the web page 813 allows a user to send messages to the IFD-communication application 805 on the IFD without the messages passing through the web server on the server. In some embodiments, after the web page 813 is received by the browser 801, no additional information needs to be received from the web server on the server.

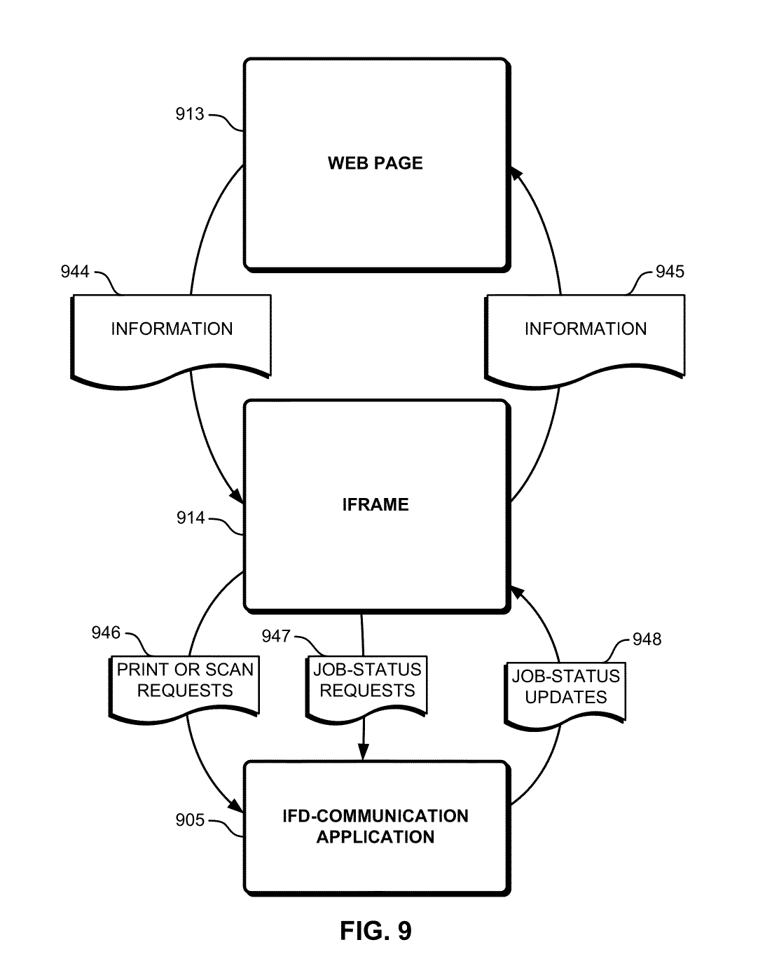

FIG. 9 illustrates an example embodiment of the flow of information in a system for communicating with an IFD. The system includes one or more computing devices that implement a web page 913, and iframe 914, and an IFD-communication application 905. The web page 913 sends first information 944 (e.g., requests, messages, replies) to the iframe 914. The iframe 914 sends print or scan requests 946 and sends job-status requests 947 to the IFD-communication application 905 and sends second information 945 (e.g., requests, messages, replies, information received from the IFD-communication application 905) to the web page 913. The IFD-communication application 905 sends job-status updates 948 and other information to the iframe 914.

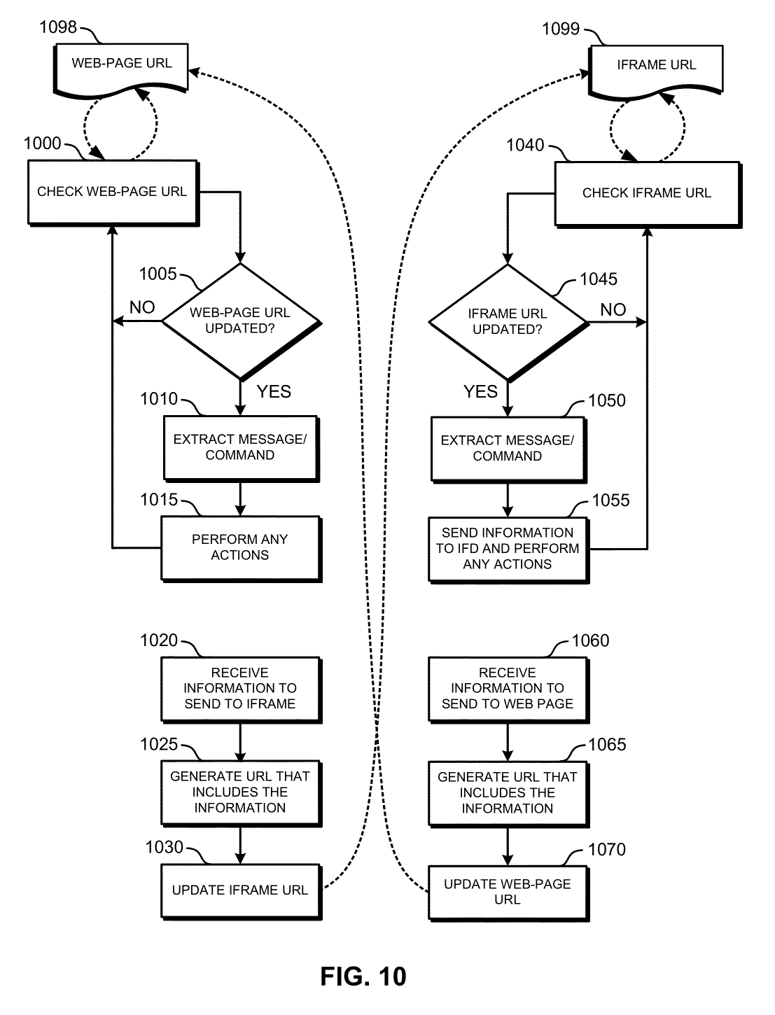

FIG. 10 illustrates example embodiments of operational flows for communicating with an IFD. At least some of the four operational flows that are illustrated by FIG. 10 may execute concurrently. A first flow starts in block 1000, where a web-page URL 1098 is checked (e.g., by a script that operates on the web page). The first flow then moves to block 1005, where it is determined if the web-page URL 1098 has been updated. If it is determined that the web-page URL 1098 has not been updated (block 1005=NO), then the first flow returns to block 1000. If it is determined that the web-page URL 1098 has been updated (block 1005=YES), then the first flow moves to block 1010. In block 1010, any messages, requests, commands, or other information are extracted from the web-page URL 1098. The first flow then proceeds to block 1015, where the web page performs any actions (e.g., responds to requests, updates the display of web page), and the first flow then returns to block 1000.

The second flow may begin in response to an interrupt, a function call, a timer, etc. For example, the second flow may begin in response to the activation of a control on the web page. The second flow starts in block 1020, where information that is to be sent to an iframe is received or determined by a web page. Then the second flow proceeds to block 1025, where the web page generates a URL that includes the information that is to be sent. Finally, the second flow moves to block 1030, where the iframe URL 1099 is changed to the URL that was generated in block 1025. The second flow then ends, although it may be started again.

The third flow starts in block 1040, where an iframe URL 1099 is checked (e.g., by a script that operates on the iframe). The third flow then moves to block 1045, where it is determined if the iframe URL 1099 has been updated. If it is determined that the iframe URL 1099 has not been updated (block 1045=NO), then the third flow returns to block 1040. If it is determined that the iframe URL 1099 has been updated (block 1045=YES), then the third flow moves to block 1050. In block 1050, any messages, requests, commands, or other information are extracted from the iframe URL 1099. The third flow then proceeds to block 1055, where the iframe sends the messages, requests, commands, or other information to the IFD by means of the IFD-communication application, and the IFD performs any actions. The third flow then returns to block 1040.

Finally, the fourth flow may begin in response to an interrupt, a function call, a timer, etc. For example, it may begin in response to being called by a function in the iframe that polls for messages from the IFD-communication application. The fourth flow starts in block 1060, where information that is to be sent to a web page is received (e.g., from an IFD-communication application) by an iframe. Then the fourth flow proceeds to block 1065, where the iframe generates a URL that includes the information that is to be sent. Finally, the fourth flow moves to block 1070, where the web-page URL 1098 is changed to the URL that was generated in block 1065. The fourth flow then ends, though it may be started again.

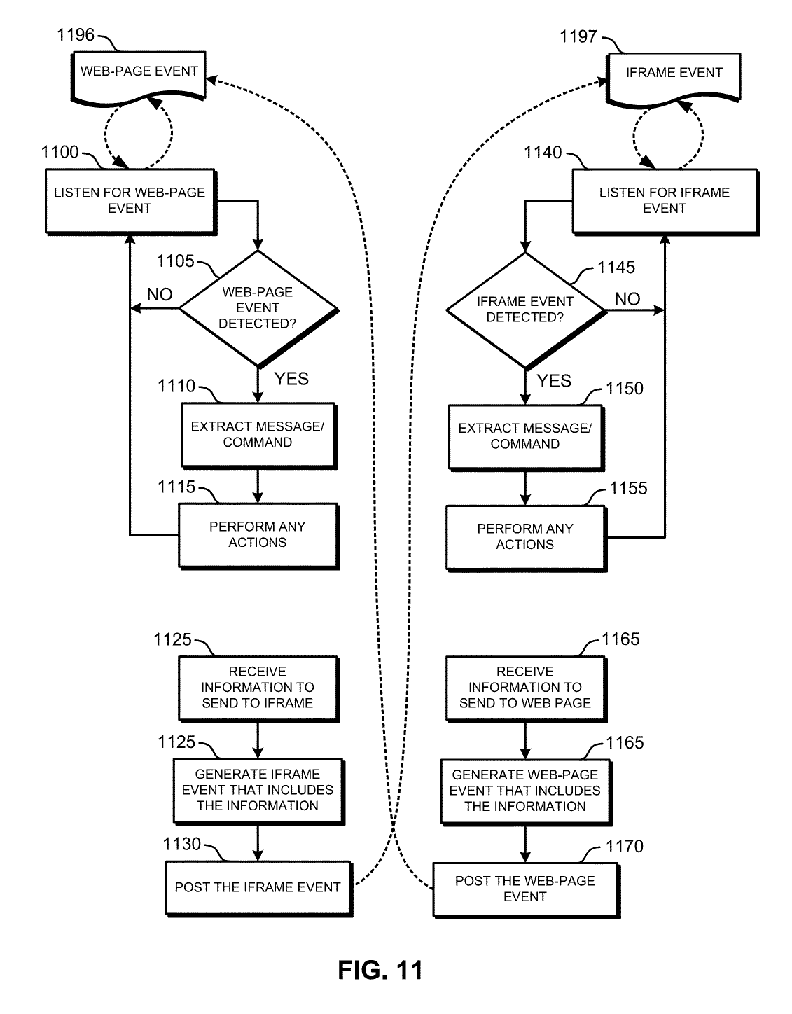

FIG. 11 illustrates example embodiments of operational flows for communicating with an IFD. At least some of the four operational flows that are illustrated by FIG. 11 may execute concurrently. A first flow starts in block 1100, where a web page (e.g., a script that operates on the web page) listens for a web-page event 1196. The first flow then moves to block 1105, where it is determined if a web-page event 1196 has been detected. If it is determined that a web-page event 1196 has not been detected (block 1105=NO), then the first flow returns to block 1100. If it is determined that a web-page event 1196 has been detected (block 1105=YES), then the first flow moves to block 1110. In block 1110, any messages, requests, commands, or other information are extracted from the web-page event 1196. The first flow then proceeds to block 1115, where the web page performs any actions (e.g., updates the web page based on received information), and the first flow then returns to block 1100.

The second flow may begin in response to an interrupt, a function call, a timer, etc. The second flow starts in block 1120, where information that is to be sent to an iframe is received by a web page. Then the second flow proceeds to block 1125, where the web page generates an iframe event 1197 that includes the information that is to be sent. Finally, the second flow moves to block 1130, where the iframe event 1197 is posted by the web page. For example, the iframe event 1197 may be posted by generating a message event, for example by using window.postMessage. The window.postMessage function creates a message event that is received by the iframe in this flow. The second flow then ends, though it may be started again.

The third flow starts in block 1140, where an iframe (e.g., a script that operates on the iframe) listens for an iframe event 1197. The third flow then moves to block 1145, where it is determined if an iframe event 1197 has been detected. If it is determined that an iframe event 1197 has not been detected (block 1145=NO), then the third flow returns to block 1140. If it is determined that an iframe event 1197 has been detected (block 1145=YES), then the third flow moves to block 1150. In block 1150, any messages, requests, commands, or other information are extracted from the iframe event 1197. The third flow then proceeds to block 1155, where the iframe sends the messages, requests, commands, or other information to the IFD, and the IFD performs any actions. The third flow then returns to block 1140.

Additionally, the fourth flow may begin in response to an interrupt, a function call, a timer, etc. The fourth flow starts in block 1160, where information that is to be sent to a web page is received (e.g., from an IFD-communication application) by an iframe. Then the fourth flow proceeds to block 1165, where the iframe generates a web-page event 1196 that includes the information that is to be sent. Finally, the fourth flow moves to block 1170, where the web-page event 1196 is posted by the iframe. The fourth flow then ends, though it may be started again.

FIG. 12 illustrates an example embodiment of a user interface 1291 that may be displayed on a web page. The user interface 1291 includes several controls 1293A-E. When a control 1293 is activated, a script on the web page initiates the operations that cause the operations that are associated with the control 1293 to be performed. For example, if the session-guide control 1293B is activated, a script on the web page sends a request to print a session guide to an iframe, which then relays the request to an IFD-communication application. The IFD-communication application then starts the operations on the IFD that perform the request.

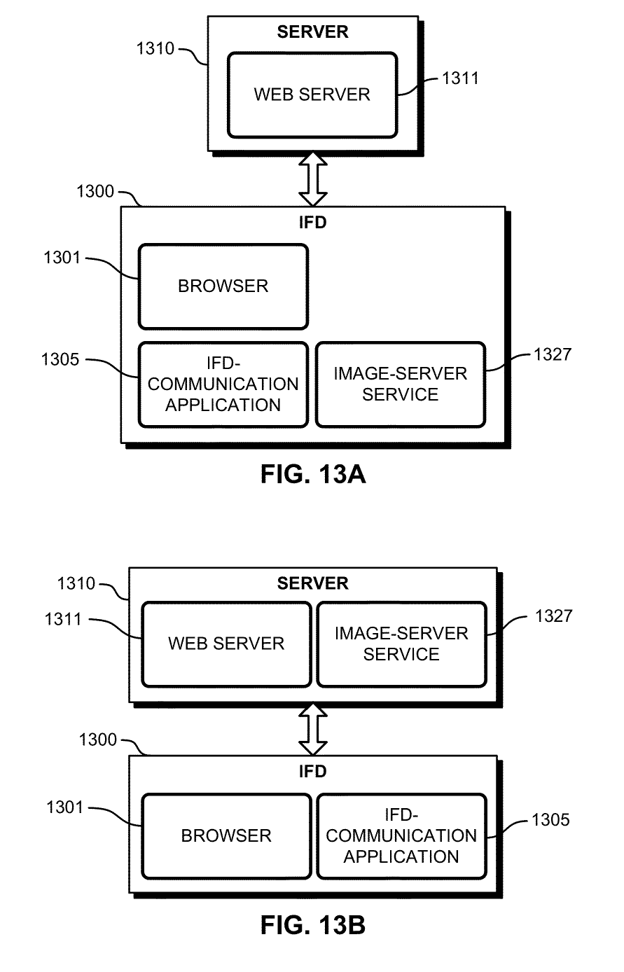

FIG. 13A illustrates an example embodiment of a system for communicating with an IFD. In this embodiment, a server 1310 operates a web server 1311, and an IFD 1300 operates a browser 1301, an IFD-communication application 1305, and an image-server service 1327.

FIG. 13B illustrates an example embodiment of a system for communicating with an IFD. In this embodiment, a server 1310 operates a web server 1311 and an image-server service 1327. Also, an IFD 1300 operates a browser 1301 and an IFD-communication application 1305.

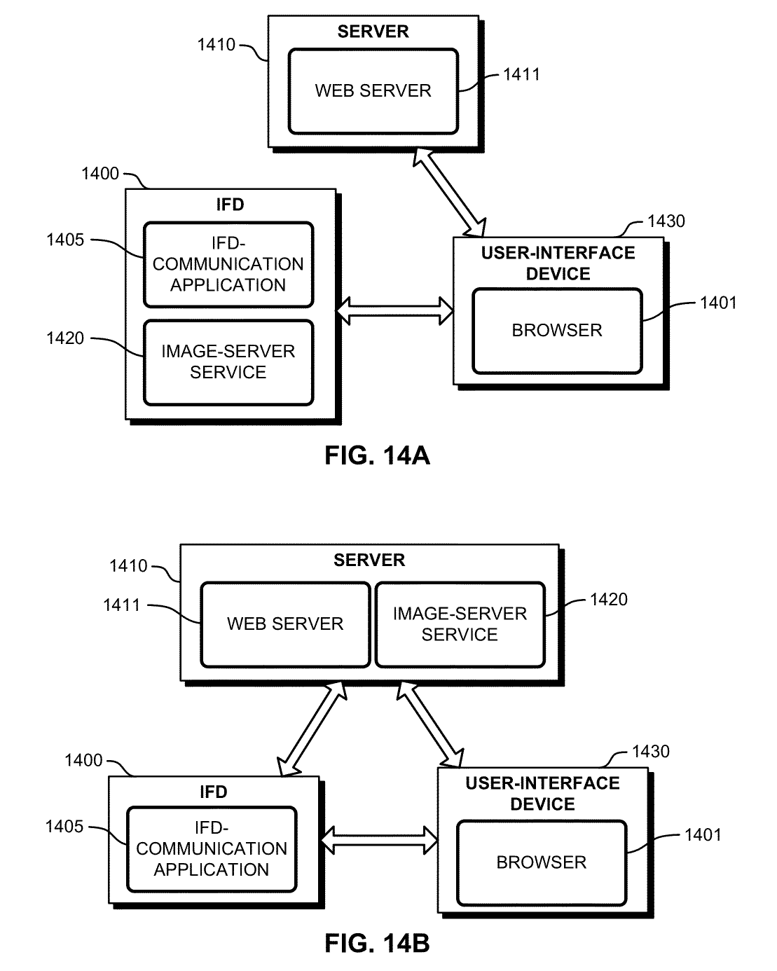

FIG. 14A illustrates an example embodiment a system for communicating with an IFD. In this embodiment, a server 1410 operates a web server 1411, and a user-interface device 1430 operates a browser 1401. Also, an IFD 1400 operates an IFD-communication application 1405 and an image-server service 1427.

FIG. 14B illustrates an example embodiment a system for communicating with an IFD. In this embodiment, a server 1410 operates a web server 1411 and an image-server service 1427. Also, an IFD 1400 operates an IFD-communication application 1405, and a user-interface device 1430 operates a browser 1401.

The above-described devices, systems, and methods can be implemented by providing one or more computer-readable media that contain computer-executable instructions for realizing the above-described operations to one or more computing devices that are configured to read and execute the computer-executable instructions. Thus, the systems or devices perform the operations of the above-described embodiments when executing the computer-executable instructions. Also, an operating system on the one or more systems or devices may implement at least some of the operations of the above-described embodiments. Thus, the computer-executable instructions or the one or more computer-readable media that contain the computer-executable instructions constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and semiconductor memory (including flash memory, DRAM, SRAM, a solid state drive, EPROM, EEPROM)) can be employed as a computer-readable medium for the computer-executable instructions. The computer-executable instructions may be stored on a computer-readable storage medium that is provided on a function-extension board inserted into a device or on a function-extension unit connected to the device, and a CPU provided on the function-extension board or unit may implement at least some of the operations of the above-described embodiments.

The scope of the claims is not limited to the above-described embodiments and includes various modifications and equivalent arrangements. Also, as used herein, the conjunction “or” generally refers to an inclusive “or,” though “or” may refer to an exclusive “or” if expressly indicated or if the context indicates that the “or” must be an exclusive “or.”

What is claimed is:

1. A device for communicating with an image-forming device, the device comprising:
one or more computer-readable media;
one or more input interfaces;
one or more output interfaces; and
one or more processors that are coupled to the one or more computer-readable media, the one or more input interfaces, and the one or more output interfaces, and that are configured to cause the device to perform operations including
obtaining a web page from a web server, wherein the web page includes an iframe;
populating the iframe with information received from a first image-forming-apparatus-communication application;
sending first information from the web page to the iframe; and
sending the first information from the iframe to a second image-forming-apparatus-communication application.

2. The device of claim 1, wherein the information identifies an image and a storage location of the image, and
the one or more processors are further configured to cause the device to retrieve the image from the storage location of the image.

3. The device of claim 1, wherein the one or more processors are further configured to cause the device to
receive, at the iframe, second information send from the second image-forming-apparatus-communication application; and
send the second information from the iframe to the web page.

4. The device of claim 3, wherein the one or more processors are further configured to cause the device to send the second information from the iframe to the web page by changing a URL of the web page and by reading the changed URL of the web page at the web page.

5. The device of claim 1, wherein the one or more processors are further configured to cause the device to send the first information from the web page to the iframe by changing a URL of the iframe and by reading the changed URL of the iframe at the iframe.

6. The device of claim 1, wherein the one or more processors are further configured to cause the device to
implement a script in the web page that polls for changes to a URL of the web page; and
implement a script in the iframe that polls for changes to the URL of the iframe.

7. The device of claim 1, wherein the one or more processors are further configured to cause the device to
activate a control on the web page based on received user input,
wherein the first information is associated with the control, and
wherein the first information is sent from the web page to the iframe in response to the activation of the control.

8. The device of claim 1, wherein the first image-forming-apparatus-communication application is the same application as the second image-forming-apparatus-communication application.

9. A method for communicating with an image-forming device, the method comprising:
obtaining a web page from a web server at a browser, wherein the web page includes an iframe;
rendering the web page on the browser;
populating the iframe with information received from an image-forming-apparatus-communication application;
sending first information from the web page to the iframe; and
sending the first information from the iframe to the image-forming-apparatus-communication application.

10. The method of claim 9, wherein the first information includes a status request or a print request.

11. The method of claim 9, further comprising:
operating a script on the web page; and
operating a script on the iframe,
wherein the script on the web page sends the first information to the script on the iframe.

12. The method of claim 9, wherein sending the first information includes
generating a URL that encodes the first information; and
changing a URL of the iframe to the URL that encodes the first information.

13. The method of claim 9, further comprising:
receiving second information from the image-forming-apparatus-communication application at the iframe; and
sending the second information from the iframe to the web page.

14. One or more computer-readable media storing instructions that, when executed by one or more computing devices, cause the one or more computing devices to perform operations comprising:
obtaining a web page from a web server at a browser, wherein the web page includes an iframe;
rendering the web page on the browser;
populating the iframe with information received from an image-forming-apparatus-communication application;
sending first information from the web page to the iframe; and
sending the first information from the iframe to the image-forming-apparatus-communication application.

15. The one or more computer-readable media of claim 14, wherein the browser is implemented on a different computing device than the computing device that implements the image-forming-apparatus-communication application.

16. The one or more computer-readable media of claim 14, wherein the browser and the image-forming-apparatus-communication application are implemented on a first image-forming device.

17. The one or more computer-readable media of claim 14, wherein the operations further comprise:
receiving second information from the image-forming-apparatus-communication application at the iframe; and
sending the second information from the iframe to the web page.

18. The one or more computer-readable media of claim 17, wherein the operations further comprise updating the web page based on the second information.

19. The one or more computer-readable media of claim 14, wherein the first information is sent from the web page to the iframe via a message event.
